(19) United States
(12) Patent Application Publication
(10) Pub. No.: US 2025/0304137 A1
(43) Pub. Date: Oct. 2, 2025

(54) LOAD PLANNER STATION DEVICES, SYSTEMS, AND METHODS

(71) Applicant: Definitive Technology Group, LLC, Wilmington, MA (US)

(72) Inventors: Calvin Ting, Seattle, WA (US); Stephen Shaheen, Wilmington, MA (US)

(73) Assignee: Definitive Technology Group, LLC, Wilmington, MA (US)

(21) Appl. No.: 18/864,805

(22) PCT Filed: May 17, 2023
(86) PCT No.: PCT/US2023/022554

§ 371 Date: Nov. 11, 2024

Related U.S. Application Data
(60) Provisional application No. 63/343,052, filed on May 17, 2022.

(51) Int. Cl. B62B 5/00; B62B 3/00

(52) U.S. Cl. CPC B62B 5/0093; B62B 3/008; B62B 2202/56

(57) ABSTRACT

Load planner station devices, systems, and methods. The present disclosure includes disclosure of a load planner station, comprising a skid base configured to cover and slide upon a plurality of swivel casters of a swivel caster platform, a main compartment positioned upon the skid base, the main compartment defining an upper work surface, one or more peripheral devices positioned upon the upper work surface, one or more rechargeable batteries positioned within the main compartment and configured to provide power to the one or more peripheral devices, and one or more guard rails coupled to and extending upward from the skid base.

### PRIORITY

The present application is related to, and claims the priority benefit of, U.S. Provisional Patent Application Ser. No. 63/343,052, filed May 17, 2022, the contents of which are incorporated herein directly and by reference in their entirety.

### BRIEF SUMMARY

The present disclosure includes disclosure of a load planner station, comprising a skid base configured to cover and slide upon a plurality of swivel casters of a swivel caster platform, a main compartment positioned upon the skid base, the main compartment defining an upper work surface, one or more peripheral devices positioned upon the upper work surface, one or more rechargeable batteries positioned within the main compartment and configured to provide power to the one or more peripheral devices, and one or more guard rails coupled to and extending upward from the skid base.

The present disclosure includes disclosure of a load planner station, further comprising one or more additional guard rails coupled to and extending outward from the main compartment.

The present disclosure includes disclosure of a load planner station, configured to slide upon and cover at least twenty-five of the swivel casters at any given time.

The present disclosure includes disclosure of a load planner station, wherein the skid base has dimensions at or about fifty-four inches wide by fifty-four inches deep.

The present disclosure includes disclosure of a load planner station, wherein the skid base has a thickness at or between ⅜″ and 2″.

The present disclosure includes disclosure of a load planner station, further comprising one or more skid bumpers positioned along a perimeter of the skid base.

The present disclosure includes disclosure of a load planner station, wherein the one or more peripheral devices comprises one or more monitors or screens.

The present disclosure includes disclosure of a load planner station, wherein the one or more peripheral devices comprises one or more monitor or screen stands positioned upon the upper work surface of the main compartment.

The present disclosure includes disclosure of a load planner station, wherein the one or more peripheral devices comprises one or more beacon lights.

The present disclosure includes disclosure of a load planner station, wherein the one or more peripheral devices comprises one or more speakers.

The present disclosure includes disclosure of a load planner station, wherein the one or more peripheral devices comprises one or more device holders.

The present disclosure includes disclosure of a load planner station, wherein the one or more device holders are configured to hold one or more peripheral devices selected from the group consisting of one or more smartphones, one or more radios, one or more radio handsets, one or more scanners, and one or more lamps.

The present disclosure includes disclosure of a load planner station, wherein the one or more peripheral devices comprises one or more antennas.

The present disclosure includes disclosure of a load planner station, further comprising wiring connected to the one or more rechargeable batteries and to one or more peripherals positioned upon the upper work surface of the main compartment.

The present disclosure includes disclosure of a load planner station, wherein the main compartment comprises one or more doors providing access to one or more internal spaces of the main compartment.

The present disclosure includes disclosure of a load planner station, wherein one or more printers are positioned within the one or more internal spaces.

The present disclosure includes disclosure of a load planner station, wherein one or more radio base stations are positioned within the one or more internal spaces.

The present disclosure includes disclosure of a load planner station, wherein one or more power strips or surge protectors are positioned within the one or more internal spaces.

The present disclosure includes disclosure of a load planner station, wherein one or more laptops are positioned within the one or more internal spaces.

The present disclosure includes disclosure of a load planner station, wherein the main compartment is insulated with an insulative material.

The present disclosure includes disclosure of a load planner station, further comprising a handle extending from the main compartment.

The present disclosure includes disclosure of a load planner station, further comprising one or more clipboard or document holders coupled to the main compartment.

The present disclosure includes disclosure of a load planner station, further comprising one or more bar brakes, each comprising an elongated bar with a grip portion, configured to be pushed through one or more apertures defined in the skid base so to lock the load planner station in placer relative to the swivel caster platform.

The present disclosure includes disclosure of a load planner station, as shown and/or described herein.

The present disclosure includes disclosure of a load planner station system configured for movement upon a swivel caster platform, as shown and/or described herein.

The present disclosure includes disclosure of a method of using a load planner station, as shown and/or described herein.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows a front perspective view of a load planner station, according to at least one exemplary embodiment of the present disclosure;

FIG. 2 shows a front view of a load planner station, according to at least one exemplary embodiment of the present disclosure;

FIG. 3 shows a rear perspective view of a load planner station, according to at least one exemplary embodiment of the present disclosure; and

FIG. 4 shows a swivel caster platform having a plurality of swivel casters, according to at least one exemplary embodiment of the present disclosure.

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present disclosure includes disclosure of a load planner station, configured to move along a wheeled deck, as shown and/or described herein.

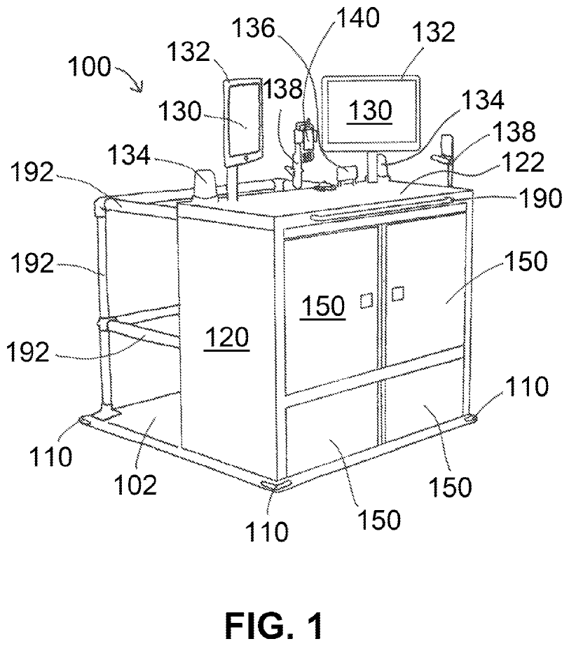

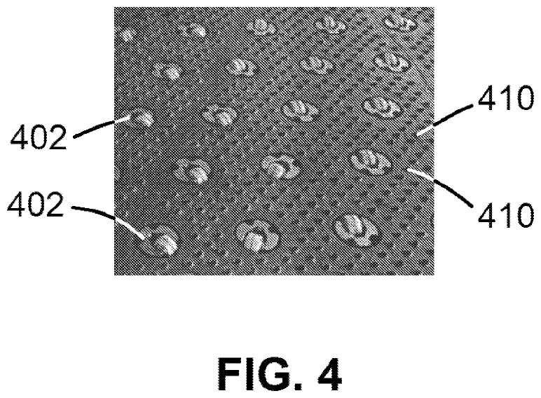

An exemplary load planner station 100 of the present disclosure is shown in FIG. 1. As shown therein, load planner station 100 comprises a skid base 102 configured to cover and slide upon a plurality of swivel casters 402 of a swivel caster platform 400, such as shown in FIG. 4. In at least one embodiment, skid base 102 is sized and shaped (configured) to cover and slide upon at or approximately twenty-five (25) swivel casters 402 at any given time. In at least one embodiment, skid base 102 has dimensions at or about fifty-four inches (54″) by fifty-four inches (54″), with a thickness between ⅜″ and about 2″. Load planner stations 100 with sufficiently large skid bases 102 are therefore configured to remain on, and not fall off of, a raised swivel caster platform 400, as said platforms have a plurality of perimeter flanges configured to contact/engage skid base 102, preventing skid base 102 from sliding off caster platform 400. One or more skid bumpers 110 can be positioned along various portions of a perimeter of said skid base 102, such as on the sides or relative corners, as shown in FIG. 1.

Exemplary load planner stations 100 of the present disclosure comprise a main compartment 120, such as shown in FIG. 1. Main compartments 120 of the present disclosure therefore define a work surface 122, namely an uppermost portion of main compartment 120. Work surface 122, in various embodiments, can have an area of or about one-half of the area of the skid base 102, such as, for example, a fifty-four inch (54″) wide and twenty-five inch (25″) deep work surface 122. Work surface 122 can have any number of features or peripherals extending therefrom or formed as part thereof, such as, for example, one or more monitors or screens 130, one or more monitor or screen stands 132, one or more beacon lights 134, one or more speakers 136, one or more device holders 138 (such as those configured to hold one or more peripheral devices 140, including, but not limited to, one or more smartphones, radios, radio handsets, scanners, lamps, and the like), one or more antennas 142, and the like, with optional wiring 144 present within or upon or coupled to the one or more monitors or screens 130, the one or more monitor or screen stands 132, the one or more beacon lights 134, the one or more speakers 136, the one or more device holders 138, and/or the one or more peripheral devices 140, such as, for example, to connect said items to a source of power, including but not limited to a rechargeable battery 162, either directly or indirectly, such as by way of a power strip or surge protector 164, as discussed in further detail herein.

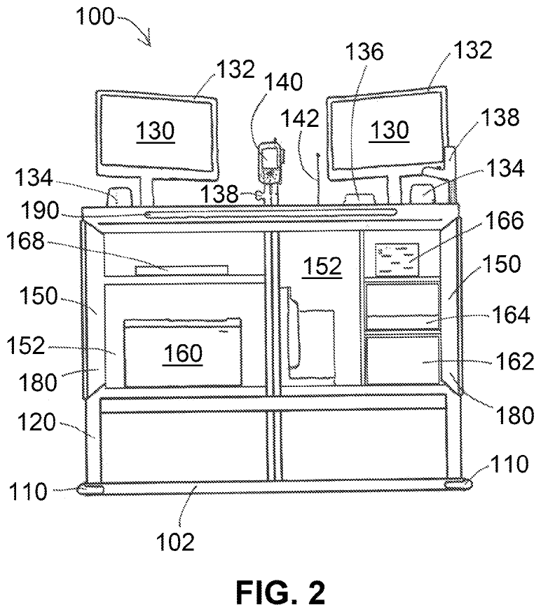

Main compartments 120 of load planner stations 100 of the present disclosure can have one or more doors 150, providing access to one or more internal spaces 152 of main compartment 120. As shown in FIG. 2, for example, internal spaces 152 can be sized and shaped (configured) to receive any number of items, including, but not limited to, one or more printers 160, one or more rechargeable batteries 162, one or more power strips or surge protectors 164, one or more radio base stations 166, one or more laptops 168, and the like. Main compartments 120, including said doors 150, can be insulated with an insulative material 180, so to maintain a reliable working temperature for electronics provided within said main compartments 120.

Load planner stations 100 of the present disclosure can be moved relative to a swivel caster platform 400 by way of engaging, for example, main compartment 120, handle 190 at a relative front of main compartment 120, and/or one or more guard rails 192 coupled to skid base 102 and/or main compartment 120 of said load planner stations 100. Guard rails 192, in addition to aiding in moving load planner stations 100 relative to caster platform 400, are also used to prevent people from riding on the skid base 102 of load planner station 100.

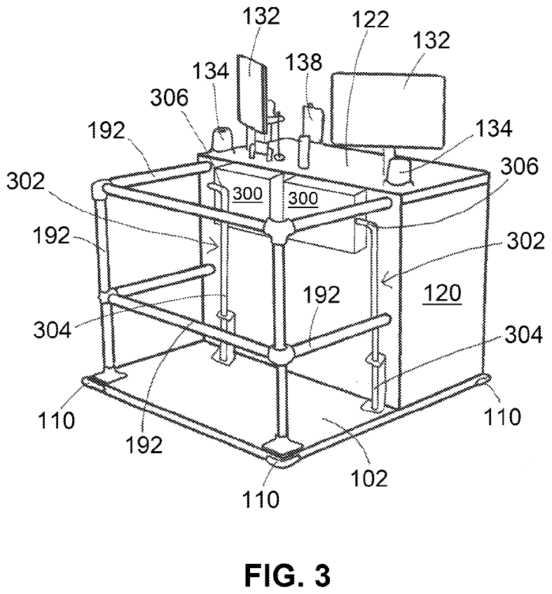

FIG. 3 shows a rear perspective view of an exemplary load planner station 100 of the present disclosure. As shown therein, one or more clipboard or document holders 300 can be coupled to or formed as part of main compartment 120. One or more bar brakes 302, comprising an elongated bar 304 with a bar grip portion 306 configured to be engaged by a user and pushed through one or more corresponding base apertures 410 so that a distal portion of elongated bar 304 can fit within holes, such as ⅜″ diameter holes, defined within caster platform 400. Engagement of said bar brakes 302 allow a user to “lock” said load planner station 100 in place relative to caster platform 400 as may be desired.

While various embodiments of load planner station systems and devices and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A load planner station, comprising:
a skid base configured to cover and slide upon a plurality of swivel casters of a swivel caster platform;
a main compartment positioned upon the skid base, the main compartment defining an upper work surface;
one or more peripheral devices positioned upon the upper work surface;
one or more rechargeable batteries positioned within the main compartment and configured to provide power to the one or more peripheral devices; and
one or more guard rails coupled to and extending upward from the skid base.

2. The load planner station of claim 1, further comprising:
one or more additional guard rails coupled to and extending outward from the main compartment.

3. The load planner station of claim 1, configured to slide upon and cover at least twenty-five of the swivel casters at any given time.

4. The load planner station of claim 1, wherein the skid base has dimensions at or about fifty-four inches wide by fifty-four inches deep.

5. The load planner station of claim 1, wherein the skid base has a thickness at or between ⅜″ and 2″.

6. The load planner station of claim 1, further comprising:
one or more skid bumpers positioned along a perimeter of the skid base.

7. The load planner station of claim 1, wherein the one or more peripheral devices comprises one or more monitors or screens.

8. The load planner station of claim 1, wherein the one or more peripheral devices comprises one or more monitor or screen stands positioned upon the upper work surface of the main compartment.

9. The load planner station of claim 1, wherein the one or more peripheral devices comprises one or more beacon lights.

10. The load planner station of claim 1, wherein the one or more peripheral devices comprises one or more speakers.

11. The load planner station of claim 1, wherein the one or more peripheral devices comprises one or more device holders.

12. The load planner station of claim 11, wherein the one or more device holders are configured to hold one or more peripheral devices selected from the group consisting of one or more smartphones, one or more radios, one or more radio handsets, one or more scanners, and one or more lamps.

13. The load planner station of claim 1, wherein the one or more peripheral devices comprises one or more antennas.

14. The load planner station of claim 1, further comprising:
wiring connected to the one or more rechargeable batteries and to one or more peripherals positioned upon the upper work surface of the main compartment.

15. The load planner station of claim 1, wherein the main compartment comprises one or more doors providing access to one or more internal spaces of the main compartment.

16. The load planner station of claim 15, wherein one or more printers are positioned within the one or more internal spaces.

17. The load planner station of claim 1, wherein one or more radio base stations are positioned within the one or more internal spaces.

18. The load planner station of claim 1, wherein one or more power strips or surge protectors are positioned within the one or more internal spaces.

19. The load planner station of claim 1, wherein one or more laptops are positioned within the one or more internal spaces.

20. The load planner station of claim 1, wherein the main compartment is insulated with an insulative material.

21. The load planner station of claim 1, further comprising:
a handle extending from the main compartment.

22. The load planner station of claim 1, further comprising:
one or more clipboard or document holders coupled to the main compartment.

23. The load planner station of claim 1, further comprising:
one or more bar brakes, each comprising an elongated bar with a grip portion, configured to be pushed through one or more apertures defined in the skid base so to lock the load planner station in placer relative to the swivel caster platform.
